(19) United States
(12) Patent Application Publication
(10) Pub. No.: US 2026/0142404 A1
(43) Pub. Date: May 21, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Hajime MATSUI, Mie (JP)

(21) Appl. No.: 19/119,406

(22) PCT Filed: Sep. 25, 2023
(86) PCT No.: PCT/JP2023/034661

§ 371 Date: Apr. 9, 2025

(30) Foreign Application Priority Data
Oct. 14, 2022 (JP) 2022-165372

(51) Int. Cl. H01R 13/506

(52) U.S. Cl. CPC H01R 13/506

(57) ABSTRACT

A connector having a united structure of housings includes a first housing including an outer wall and an inner wall located inside the outer wall, and a second housing to be united with the first housing. The second housing includes a locking piece having a locking piece body to be arranged between the outer wall and the inner wall and a detecting projection projecting toward the outer wall from the locking piece body. One of the locking piece body and the inner wall is formed with a locking protrusion and the other is formed with a locking recess to be locked to the locking protrusion. The outer wall is formed with a detection opening, in which the detecting projection is arranged.

### TECHNICAL FIELD

The present disclosure relates to a connector.

### BACKGROUND

Patent Document 1 discloses a technique for confirming an inserted stat of a female terminal by inserting a first detecting portion in the form of a flat rectangular column into an opening of a connector housing and detecting the deflection and deformation of a locking lance based on whether or not the inserted first detecting portion has contacted the locking lance.

### PRIOR ART DOCUMENT

### Patent Document

Patent Document 1: JP 2015-230857 A

### SUMMARY OF THE INVENTION

### Problems to be Solved

If a first housing includes a plurality of walls, a second housing may be locked to an inner wall. In this case, it is difficult to observe a locking structure from outside and detect whether or not locking is suitable.

Note that, assuming the application of Patent Document 1 described above, the elongated detecting portion is inserted between the walls. Since the elongated detecting portion is poor in strength, it is desired to be able to detect the suitability of the locking structure by another means.

Accordingly, the present disclosure aims to enable easy detection of the suitability of a locked state when a second housing is united with a first housing including an inner wall and an outer wall by a locking structure.

### Means to Solve the Problem

The present disclosure is directed to a connector having a united structure of housings, the connector being provided with a first housing including an outer wall and an inner wall located inside the outer wall and a second housing to be united with the first housing, the second housing including a locking piece having a locking piece body to be arranged between the outer wall and the inner wall and a detecting projection projecting toward the outer wall from the locking piece body, one of the locking piece body and the inner wall being formed with a locking protrusion and the other being formed with a locking recess to be locked to the locking protrusion, and the outer wall being formed with a detection opening, the detecting projection being arranged in the detection opening.

### Effect of the Invention

According to the present disclosure, the suitability of a locked state can be easily detected when a second housing is united with a first housing including an inner wall and an outer wall by a locking structure.

### BRIEF DESCRIPTION OF THE DRAWINGS

FIG. 1 is a perspective view showing a connector according to an embodiment.

FIG. 2 is a perspective view showing the connector according to the embodiment.

FIG. 3 is a section along III-III of FIG. 1.

FIG. 4 is an exploded perspective view showing the connector.

FIG. 5 is an exploded perspective view partly in section showing the connector.

FIG. 6 is a section along VI-VI of FIG. 2.

FIG. 7 is a perspective view showing the connector in an abnormally locked state.

FIG. 8 is a section showing the connector in the abnormally locked state.

FIG. 9 is a diagram showing a detecting operation example of the abnormally locked state.

### DETAILED DESCRIPTION TO EXECUTE THE INVENTION

### Description of Embodiments of Present Disclosure

First, embodiments of the present disclosure are listed and described.

The connector of the present disclosure is as follows.
(1) The connector of the present disclosure having a united structure of housings is provided with a first housing including an outer wall and an inner wall located inside the outer wall and a second housing to be united with the first housing, the second housing including a locking piece having a locking piece body to be arranged between the outer wall and the inner wall and a detecting projection projecting toward the outer wall from the locking piece body, one of the locking piece body and the inner wall being formed with a locking protrusion and the other being formed with a locking recess to be locked to the locking protrusion, and the outer wall being formed with a detection opening, the detecting projection being arranged in the detection opening.

According to the present disclosure, if the locking protrusion cannot be normally locked to the locking recess, the locking piece body is resiliently deformed toward the outer wall and the detecting projection is located more outward than in a normally locked state. The suitability of the locked state is easily detected based on the position of the detecting projection in the detection opening.
(2) In the connector of (1), a projecting length of the detecting projection may be so set that the detecting projection projects outward from the outer wall when a locked state of the locking protrusion to the locking recess is abnormal.

In this way, the suitability of the locked state is easily detected based on the projecting length of the detecting projection from the outer wall.
(3) In the connector of (2), the projecting length of the detecting projection may be so set that the detecting projection is located more inward than an outer surface of the outer wall when the locked state of the locking protrusion to the locking recess is normal.

In this way, the suitability of the locked state is easily detected based on whether or not the detecting projection projects from the outer wall.
(4) In the connector of any one of (1) to (3), the first housing may include a terminal accommodating portion for accommodating a terminal including a wire connecting portion and a connecting portion to a mating terminal, and the terminal accommodating portion is open on the wire connecting portion side, and the second housing may be a cover for closing an opening of the first housing.

The suitability of a locked state of the first housing for accommodating the terminal and the cover for closing the rear opening of the first housing is easily detected.
(5) In the connector of any one of (1) to (4), the locking piece may further include a rattling preventing projection projecting toward the outer wall from the locking piece body and pressed against an inner surface of the outer wall with the locking piece body arranged between the outer wall and the inner wall.

In this case, rattling between the first and second housings is suppressed since the rattling preventing projection is pressed against the inner surface of the outer wall. Further, the rattling preventing projection presses the locking piece toward the inner wall and, hence, contributes to maintaining the locked state of the locking protrusion and the locking recess.
(6) In the connector of (5), the rattling preventing projection may be formed on a side closer to a base end than the locking protrusion or the locking recess in the locking piece body.

In this case, the rattling preventing projection can be pressed against the outer wall after the locking protrusion is locked to the locking recess. In this way, the rattling preventing projection can prevent the rattling without hindering workability for locking the locking protrusion to the locking recess.
(7) In the connector of (5) or (6), the detecting projection and the rattling preventing projection may be located at positions different in a direction intersecting an insertion direction of the detecting projection. In this way, the suitability of the locked state is easily detected while the rattling is suppressed by the rattling preventing projection.
(8) In the connector of any one of (1) to (7), the outer wall may include a pair of outer side walls, the inner wall may include a pair of inner side walls located inside the pair of outer side walls and coupled by a coupling wall portion, the detection opening may be formed at a position facing the coupling wall portion, out of the outer side wall, and the detecting projection may be arranged in the detection opening outside the coupling wall portion.

In this case, since the coupling wall portion is located inside the detecting projection, the first and second housings are hardly deformed and a united state is hardly released even if a force is applied around the detection opening and to the detecting projection when the connector is inserted or withdrawn.
(9) In the connector of any one of (1) to (8), the detecting projection may be formed into a protrusion shape elongated along a projecting direction of the locking piece body.

An opening width of the detection opening can be reduced by thinning the detecting projection in this way, wherefore the strength of the outer wall is easily ensured. Further, the strength of the detecting projection is easily ensured by elongating the detecting projection.
(10) In the connector of any one of (1) to (9), the detecting projection may project toward the outer wall at least on a tip of the locking piece body.

If a locked state of the locking piece is abnormal, the tip of the locking piece body is easily located furthest on the outer wall side. Accordingly, the detecting projection projects toward the outer wall at least on the tip of the locking piece body, whereby the abnormality of the locked state is easily detected.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

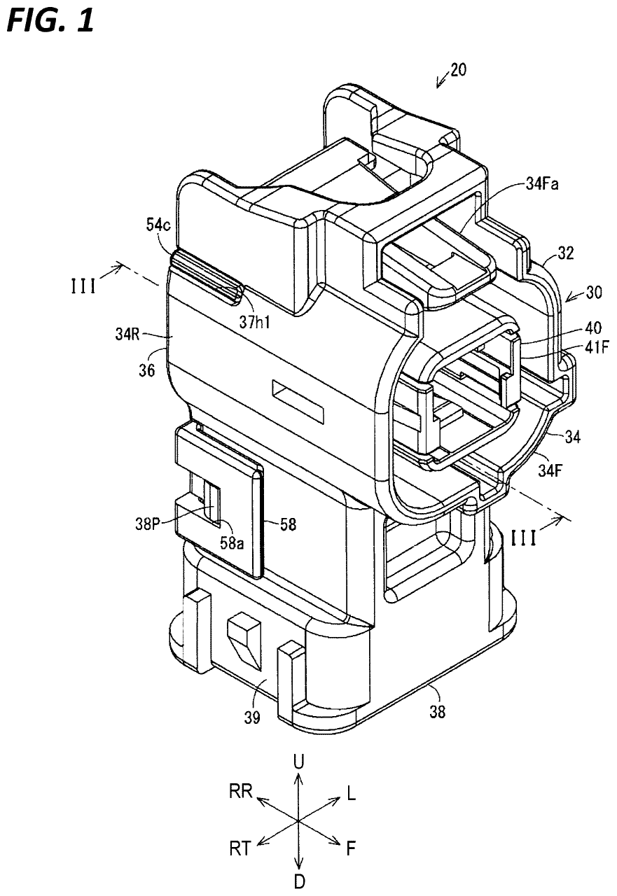

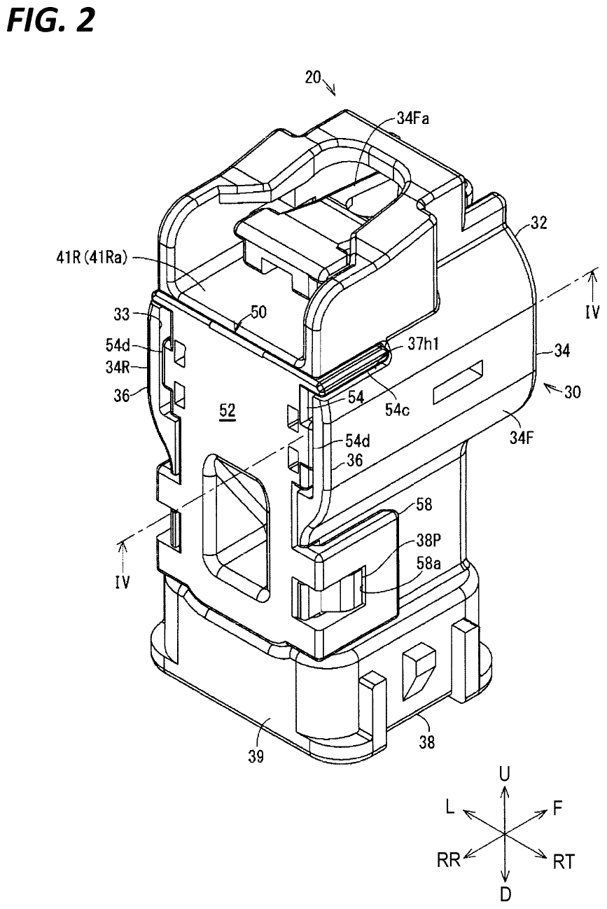

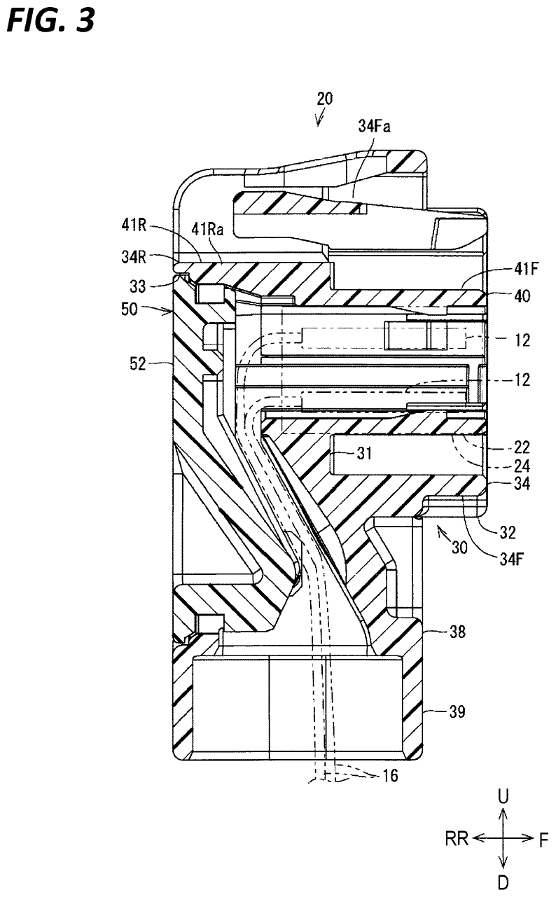

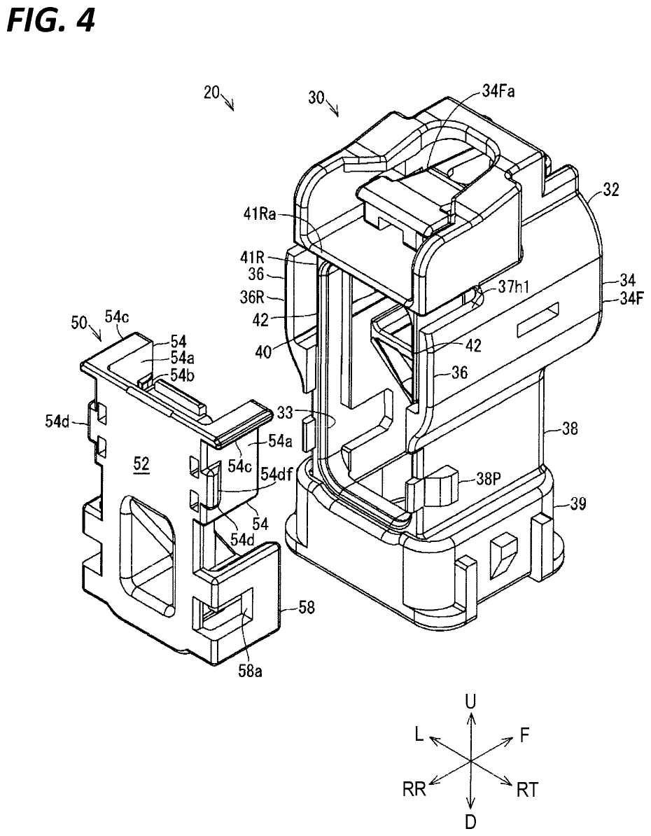

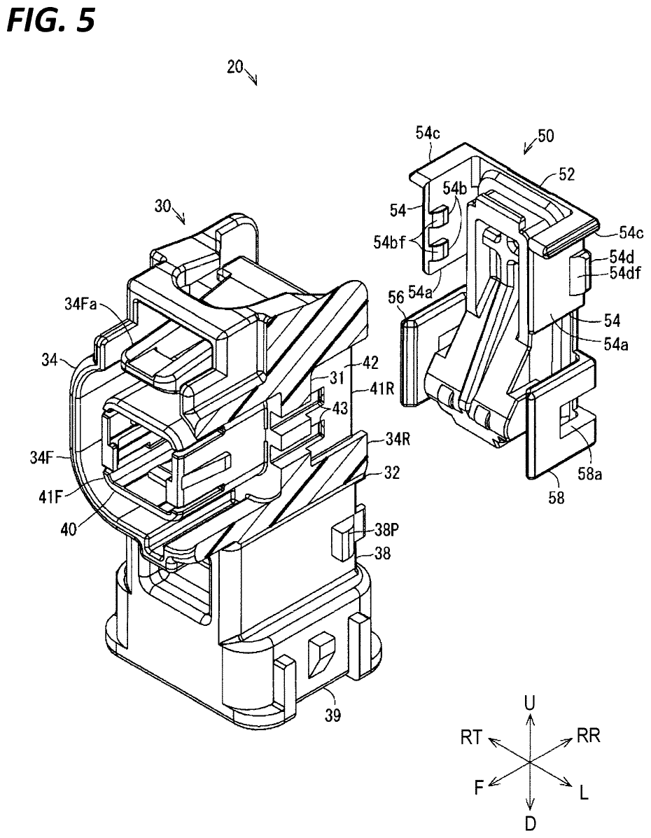

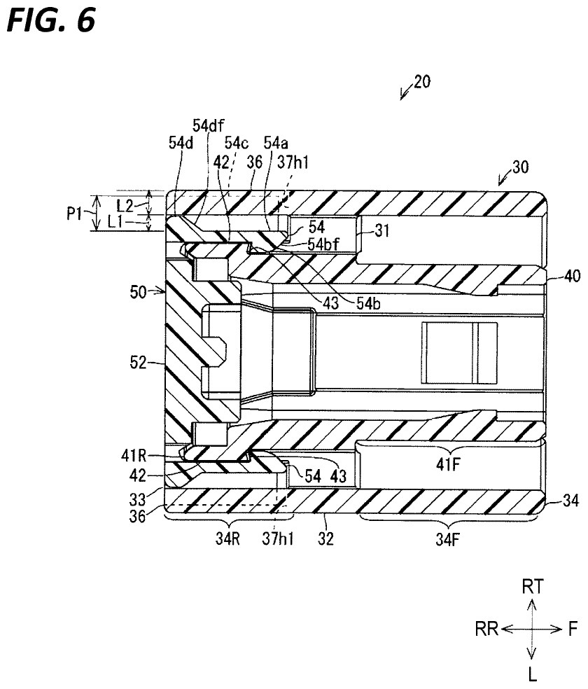

Hereinafter, a connector according to an embodiment is described. FIGS. 1 and 2 are perspective views showing a connector 20. FIG. 3 is a section along III-III of FIG. 1. FIG. 4 is an exploded perspective view showing the connector 20. FIG. 5 is an exploded perspective view partly in section showing the connector 20. FIG. 6 is a section along VI-VI of FIG. 2.

### Overall Structure

The connector 20 is a connector having a united structure of a plurality of housings. The connector 20 is provided with a first housing 30 and a second housing 50. By uniting the first and second housings 30, 50, a housing is configured which forms a space for accommodating at least terminals 12, in this embodiment, a space for accommodating the terminals 12 and wires 16 extending from the terminals 12.

The first housing 30 is a molded product from resin or the like and includes a terminal accommodating portion 32. A terminal core unit 22 is accommodated in the terminal accommodating portion 32 (see FIG. 3).

The terminal core unit 22 includes the terminals 12 and a terminal holder 24 for holding the terminals 12. The terminal 12 is a component formed, such as by press-working a metal plate, and includes a wire connecting portion and a mating terminal connecting portion. The wire connecting portion and the mating connecting portion are, for example, linearly connected. The wire connecting portion in one end part of the terminal 12 is connected to an end part of the wire 16 by crimping or the like. The mating connecting portion is, for example, formed into a tubular shape, and a pin-like or tab-like male connecting portion of a mating terminal is inserted and connected to the mating connecting portion.

The terminal holder 24 is a resin component for holding the terminals 12. For example, the terminal core unit 22 includes a plurality of the terminals 12. The terminal holder 24 holds the plurality of terminals 12 in a predetermined array while insulating the plurality of terminals 12 from each other. With the plurality of terminals 12 held by the terminal holder 24, the terminal holder 24 is held in the terminal accommodating portion 32 of the first housing 30. In this way, the plurality of terminals 12 are easily held in the predetermined array in the first housing 30.

The terminal accommodating portion 32 holds the terminals 12 inside by holding the terminal holder 24 inside. The terminal accommodating portion 32 includes an outer tube portion 34 and an inner tube portion 40 located inside the outer tube portion 34.

In this embodiment, the inner tube portion 40 is formed into a tubular shape surrounding the terminal holder 24, and the outer tube portion 34 is formed into a tubular shape surrounding the inner tube portion 40 while being spaced apart therefrom. In this embodiment, the inner tube portion 40 and the outer tube portion 34 are in the form of rectangular tubes. Here, the rectangular tube means not only a rectangular tube with right-angle corners, but also a rectangular tube with rounded corners.

The inner tube portion 40 and the outer tube portion 34 are connected via a partition wall 31 located in an axially middle part thereof. The partition wall 31 is interposed between the outer peripheral surface of the inner tube portion 40 and the inner peripheral surface of the outer tube portion 34 and functions as a spacer for forming a gap between the inner tube portion 40 and the outer tube portion 34.

Parts of the inner tube portion 40 and the outer tube portion 34 extending more toward one side (front side) than the partition wall 31 are parts to be connected to a mating connector. The part (forward extending part) of the inner tube portion 40 on the one side of the partition wall 31 is formed as a connector connecting inner end portion 41F formed into a rectangular tube shape. The connector connecting inner end portion 41F surrounds the mating terminal connecting portions of the terminals 12. The part (forward extending part) of the outer tube portion 34 on the one side of the partition wall 31 is formed as a connector connecting outer end portion 34F surrounding the connector connecting inner end portion 31F while being spaced apart therefrom. In the following description, for the sake of convenience, a side connected to the mating connector and an opposite side thereof are referred to as a front side and a rear side in an axial direction of the terminal accommodating portion 32. Further, a side where a lock piece 34F to be described later extends may be referred to as an upper side, and a side where a wire pulling-out/accommodating portion 38 extends may be referred to as a lower side. Furthermore, left and right sides may be referred to in a state facing forward based on that vertical direction.

Connecting parts of the terminals 12 and mating terminals are surrounded by the connector connecting inner end portion 41F and the connector connecting outer end portion 34F, thereby enhancing water cut-off property and protectiveness for these connected parts. Further, an annular seal can be interposed between the connector connecting inner end portion 41 and the partition wall 31 and a housing of the mating connector, whereby water cut-off property for the above connecting parts is enhanced.

Here, the connector connecting inner end portion 41F accommodates one end part (front end part) of the terminal core unit 22. A part (upper part) in a circumferential direction of the connector connecting outer end portion 34F is formed with the lock piece 34Fa to be locked to the mating connector.

Parts of the inner tube portion 40 and the outer tube portion 34 extending further rearward than the partition wall 31 are parts for accommodating the wire connecting portions of the terminals 12 and the wires 16 extending from the terminals 12.

The part of the inner tube portion 40 behind the partition wall 31 extends on an extension of the connector connecting inner end portion 41F and is formed as an inner accommodating end portion 41R in the form of a rectangular tube. A rear end part of the terminal core unit 22 is accommodated into the inner accommodating end portion 41R. Further, the wires 16 extending from the terminal core unit 22 are bent in the inner accommodating end portion 41R and drawn out in a direction intersecting an axial direction of the inner accommodating end portion 41R.

The part of the outer tube portion 34 extending further rearward than the partition wall 31 is formed as an outer accommodating end portion 34R surrounding the inner accommodating end portion 41R while being spaced apart therefrom. The outer accommodating end portion 34R extends on an extension of the connector connecting outer end portion 34F.

The lock piece 34Fa to be locked to the mating connector is formed in circumferential parts of the connector connecting outer end portion 34F and the outer accommodating end portion 34R. Wire connecting portion sides, i.e. rear sides, of the inner accommodating end portion 41R and the outer accommodating end portion 34R are open.

As described above, the inner tube portion 40 of the first housing 30 surrounds the terminal core unit 22 and the outer tube portion 34 is provided with a structure for locking the mating connector. Thus, a shape for holding the terminal core unit 22 and a shape for locking the mating connector are easily separately designed.

The first housing 30 further includes the wire pulling-out/accommodating portion 38. The wire pulling-out/accommodating portion 38 is a part molded from resin integrally with the terminal accommodating portion 32. The wire pulling-out/accommodating portion 38 is in the form of a rectangular tube. One end part of the wire pulling-out/accommodating portion 38 is connected to a part of an outer peripheral part of the outer tube portion 34. In this embodiment, the wire pulling-out/accommodating portion 38 is connected to a lower part of the outer tube portion 34 on a side opposite to the lock piece 34Fa. An internal space of the wire pulling-out/accommodating portion 38 is connected to the inner accommodating end portion 41R and a rear internal space of the outer accommodating end portion (see FIG. 3). The wires pulled out rearward from the terminal core unit 22 are bent in the inner accommodating end portion 41R and a rear space of the outer accommodating end portion and pulled out in a direction intersecting the axial direction of the terminal accommodating portion 32 through a recess in the rear opening edge.

A rear part of the wire pulling-out/accommodating portion 38 is open, and this opening is continuous with a rear opening of the inner accommodating end portion 41R. Thus, a setting opening 33 extending from a rear side of the terminal accommodating portion 32 toward a rear wall of the wire pulling-out/accommodating portion 38 is formed in the rear part of the first housing 30.

Since the setting opening 33 is open rearward of the terminal accommodating portion 32, the terminal core unit 22 is easily set in the terminal accommodating portion 32 through this setting opening 33. Further, the setting opening 33 is open toward the wire pulling-out/accommodating portion 38 from the rear side of the terminal accommodating portion 32. Thus, during a setting operation of the terminal core unit 22, the wires 16 extending from the terminal core unit 22 can be pulled out from the first housing 30 through the setting opening 33. Thus, during the setting operation of the terminal core unit 22, a handling space for the wires 16 is easily ensured.

An end part of the wire pulling-out/accommodating portion 38 on a side opposite to the terminal accommodating portion 32 is formed into an entirely surrounded pull-out end portion 39. The wires 16 pass through the inside of the wire pulling-out/accommodating portion 38 and are further pulled out to outside through the pull-out end portion 39.

The second housing 50 is a component integrally molded from resin and to be united with the first housing 30. In this embodiment, the second housing 50 is a cover for closing the setting opening 33 of the first housing 30.

That is, the second housing 50 is provided with a cover body 52 for closing the setting opening 33. The cover body 52 is shaped to be fittable into the setting opening 33. With the terminal core unit 22 accommodated in the terminal accommodating portion 32 and the wires 16 extending from the terminal core unit 22 accommodated in the wire pulling-out/accommodating portion 38, the second housing 50 closes the setting opening 33. In this way, the terminals 12 and the wires 16 are accommodated in a space separated from outside. For example, an annular sealing portion is interposed and arranged between the cover body 52 and the setting opening 33 and an opening, through which the wires 16 extend from the wire pulling-out/accommodating portion 38, is cut off from water by a rubber plug or the like, whereby connected parts of the wire connecting portions of the terminals 12 and the wires 16 are satisfactorily cut off from water.

### Concerning Engaging Structure

The first and second housings 30, 50 are held in a united state by an engaging structure. The engaging structure of the first and second housings 30, 50 is described.

The first housing 30 includes an outer wall and an inner wall located inside the outer wall.

In this embodiment, the outer wall includes a pair of outer side walls 36. More specifically, left and right parts of the outer accommodating end portion 34R are the pair of outer side walls 36. The outer side wall 36 includes a flat plate-like part in a vertically intermediate part and curved parts connected above and below this flat plate-like part. The flat plate-like part is along the vertical direction and the front-rear direction. The curved part is a part curved toward a widthwise center of the first housing 30 while being curved to be convex outward from the upper or lower edge of the flat plate-like part. The upper and lower edges of the outer side wall 36 are a pair of support edges to be supported by a ceiling part or a bottom part of the outer accommodating end portion 34R. The outer side wall 36 is resiliently deformable in an in-out direction with the upper and lower support edges as supported parts, and a vertical central part is most easily displaced. The outer side wall 36 may be grasped as a part observable along an outward direction (i.e. leftward direction or rightward direction) orthogonal to the flat plate-like part in the vertical center.

Further, in this embodiment, the inner wall includes a pair of inner side walls 42. More specifically, left and right parts of the inner accommodating end portion 41R are the pair of inner side walls 42. The pair of inner side walls 42 are located inside the pair of outer side walls 36. The outer side surface of the inner side wall 42 is formed into a flat surface facing leftward or rightward (see FIG. 5). The upper and lower edges of the inner side wall 42 are a pair of support edges to be supported by a ceiling part or a bottom part of the inner accommodating end portion 41R. The ceiling part and the bottom part of the inner accommodating end portion 41R are coupling wall portions 41Ra for holding the pair of inner side walls 42 in a coupled state. The inner side wall 42 is resiliently deformable in the in-out direction with the upper and lower support edges by a pair of the coupling wall portions 41Ra as supported parts, and a vertical central part is most easily resiliently deformed.

The inner side wall 42 is formed with locking recesses 43 (see FIGS. 5 and 6). The locking recesses 43 are recesses, to which locking protrusions 54b to be described later are locked. The locking recess 43 only has to be recessed when viewed from the outer surface of the inner side wall 42, and may be a bottomed recess or a recess penetrating through the inner side wall.

In this embodiment, the locking recess 43 is a bottomed recess recessed at a position of the inner side wall 42 separated forward from a rear edge.

The locking recesses 43 are formed in a middle region between the upper and lower support edges of the inner side wall 42. The middle region of the inner side wall 42 between the upper and lower support edges is, for example, a middle region separated from the upper and lower support edges and, for example, a region separated inward from the supported part by the ceiling part or the bottom part of the inner accommodating end portion 41R.

In this embodiment, two locking recesses 43 are formed in one inner side wall 42. The two locking recesses 43 are formed side by side in the vertical direction of the inner side wall 42. One of the two locking recesses 43 is located between the upper support edge of the inner side wall 42 and a vertical center line of the inner side wall 42, and the other is located between the lower support edge of the inner side wall 42 and the vertical center line of the inner side wall 42. Note that the number of the locking recesses 43 is arbitrary and may be one, three or more.

The outer side wall 36 is formed with a detection opening 37h1. The detection opening 37h1 is an opening, in which a detecting projection 54c to be described later is arranged. The detection opening 37h1 is an opening penetrating through the outer side wall 36 in a thickness direction. The detection opening 37h1 may be an opening penetrating through any part of the outer side wall 36. Thus, the detection opening 37h1 may be a slit-like opening reaching the outer edge of the outer side wall 36 or may be an opening entirely surrounded by the outer side wall 36.

In this embodiment, the detection opening 37h1 is in the form of an elongated slit extending forward from the rear edge of the outer side wall 36. Further, the detection opening 37h1 is formed at a position different from the locking recess 43 in the vertical direction.

In this embodiment, the detection opening 37h1 is formed at a position of the outer side wall 36 near the upper edge. More specifically, the detection opening 37h1 is formed at a position of the outer side wall 36 facing the coupling wall portion 41Ra on the ceiling side of the inner accommodating end portion 41R in the lateral direction. Thus, if the detection opening 37h is excluded from left or right, a part of the inner accommodating end portion 41R corresponding to the coupling wall portion 41Ra on the ceiling surface can be observed.

The second housing 50 includes locking pieces 54 to be locked to the inner side walls 42 by being inserted between the outer side walls 36 and the inner side walls 42. The locking pieces 54 are locked to the inner side walls 42, and those locked parts are covered by the outer side walls 36. Thus, a worker's hand or a peripheral member hardly contacts the locking pieces 54 locked to the inner side walls 42. In this way, the locking of the locking pieces 54 is hardly accidentally released.

The locking piece 54 includes a locking piece body 54a, the locking protrusions 54b and the detecting projection 54c.

The locking piece body 54a is in the form of a plate projecting in a direction orthogonal to the cover body 52 from a side edge part of the cover body 52. Thus, if an attempt is made to close the setting opening 33 by the cover body 52, the locking piece bodies 54a are insertable between the outer side walls 36 and the inner side walls 42.

The locking piece body 54a is in the form of a flat plate arrangeable in a flat space between the outer side wall 36 and the inner side wall 42. A vertical dimension of the locking piece body 54a is, for example, set to be nearly equal to or larger than that of the inner side wall 42. A thickness of the locking piece body 54a is set to be smaller than a gap between the outer side wall 36 and the inner side wall 42. Thus, the locking piece body 54a can be resiliently deformed in the thickness direction between the outer side wall 36 and the inner side wall 42. A projecting length of the locking piece body 54a is set not to extend beyond the locking recess 43 and reach the partition wall 31 between the outer side wall 36 and the inner side wall 42.

The locking protrusion 54b is formed to project toward the inner side wall 42 from the locking piece body 54a. In this embodiment, two locking protrusions 54b are formed on the locking piece body 54a in accordance with the positions and the number of the locking recesses 43. The two locking protrusions 54b are formed away from each other in the vertical direction on the tip of the inner surface of the locking piece body 54a. The locking protrusion 54b has a guide surface 54bf having a projecting length from the inner surface of the locking piece body 54a gradually reduced toward the tip side of the locking piece body 54a. Only one locking recess may be provided.

The detecting projection 54c is formed into a projection shape projecting toward the outer side wall 36 from the locking piece body 54a. The detecting projection 54c is formed at a position to be arranged in the detection opening 37h1 with the locking piece body 54a inserted between the outer side wall 36 and the inner side wall 42.

Thus, with the locking protrusions 54b of the locking piece body 54a locked to the locking recesses 43 of the inner side wall 42, the position of the detecting projection 54c can be observed from outside through the detection opening 37h1. If the locking protrusions 54b of the locking piece body 54a are normally locked to the locking recesses 43 of the inner side wall 42, it is assumed that the locking piece body 54a extends along the outer surface of the inner side wall 42 and the detecting projection 54c is located on a back side of the detection opening 37h1. If the locking protrusions 54b of the locking piece body 54a are not normally locked to the locking recesses 43 of the inner side wall 42, it is assumed that the locking protrusions 54b ride on the outer surface of the inner side wall 42 around the locking recesses 43. In this case, the locking piece body 54a is resiliently deformed in a direction away from the inner side wall 42, wherefore the detecting projection 54c is located closer to an outer opening of the detection opening 37ha than in the normally locked state. Thus, the suitability of the locked state can be easily detected by confirming the position of the detecting projection 54c in the detection opening 37h1 from the outside of the connector 20.

More specifically, the upper side edge of the locking piece body 54a is arranged along the outer side of the coupling wall portion 41Ra on the ceiling side of the inner side wall 42 and arranged inside the detection opening 37h1. The detecting projection 54c is formed into a shape projecting toward the outer side wall 36 from the upper side edge of the locking piece body 54a.

Thus, the formation position of the detecting projection 54c is a position different from the locking protrusions 54b in a direction (vertical direction) intersecting an insertion direction of the locking piece body 54a. Thus, the detection opening 37h1 in which the detecting projection 54c is arranged hardly exposes locked parts of the locking protrusions 54b and the locking recesses 43.

The shape of the detecting projection 54c is arbitrary. In this embodiment, the detecting projection 54c is formed into a protrusion shape elongated along a projecting direction of the locking piece body 54a. More specifically, the detecting projection 54c is formed into an elongated projection shape extending along the upper side edge of the locking piece body 54a and projecting toward the outer side wall 36. Thus, the strength of the detecting projection 54c is easily improved while the detecting projection 54c is thinned. By thinning the detecting projection 54c, a width of the detection opening 37h1 can be narrowed and the strength of the outer side wall 36 is easily improved.

Further, the detecting projection 54c preferably projects toward the outer side wall 36 at least on the tip of the locking piece body 54. In this embodiment, the elongated detecting projection 54c extends beyond the locking protrusions 54b and reach the tip of the locking piece body 54a.

If the locked state of the locking protrusions 54b to the inner side wall 42 is abnormal, the locking piece body 54a is deformed with a base end as a supported part, wherefore a tip part of the locking piece body 54a is assumed to be located most distant from the inner side wall 42. If the detecting projection 54c projects toward the outer side wall 36 at least on the tip of the locking piece body 54a, a position variation of the detecting projection 54c can be increased and the abnormality of the locked state is easily detected if the locked state is abnormal.

Note that it is not essential that the detecting projection 54c has the above shape. For example, a detecting projection may be a cylindrical, rectangular column-like, hemispherical or conical projection at least partially projecting in the projecting direction of a locking piece body.

The projecting length of the detecting projection 54c is arbitrary, but is preferably so set that the detecting projection 54c projects outward from the outer side wall 36 if the locked state of the locking protrusions 54b to the locking recesses 43 is abnormal.

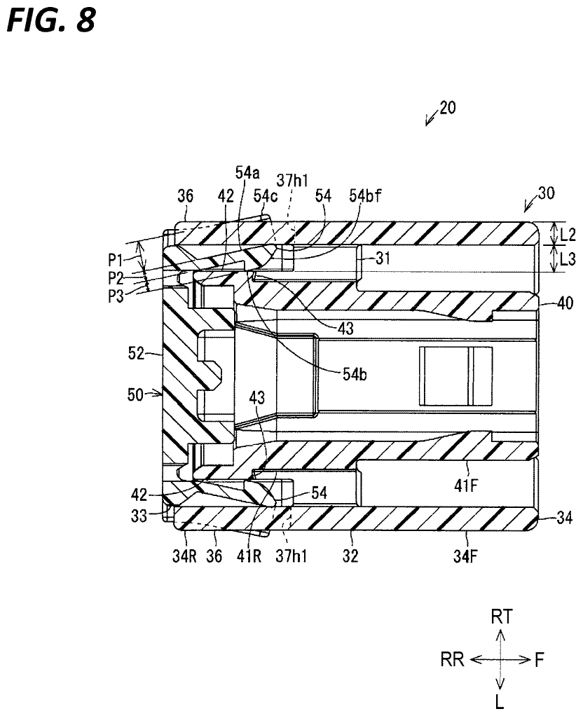

For example, it is assumed that the locking protrusions 54b are on the outer surface of the inner side wall 42 in the abnormally locked state of the locking protrusions 54b to the locking recesses 43 (see FIG. 8). In this state, a dimension (P1+P2+P3) obtained by adding a thickness P2 of the locking piece body 54a and a projecting length P3 of the locking protrusions 54b to a projecting length P1 of the detecting projection 54c is larger than a dimension (L2+L3) obtained by adding a thickness L2 of the outer side wall 36 to a gap dimension L3 between the outer side wall 36 and the inner side wall 42.

In this way, the suitability of the locked state is easily detected based on whether or not the locking protrusions 54b project from the outer side wall 36.

Further, the projecting length of the detecting projection 54c is preferably so set that the detecting projection 54c is located more inward than the outer surface of the outer side wall 36 if the locked state of the locking protrusions 54b to the locking recesses 43 is normal.

For example, it is assumed that the outer surface of the inner side wall 42 is in contact with the inner surface of the locking piece body 54a with the locking protrusions 54b normally locked to the locking recesses 43 (see FIG. 6). In this state, the projecting length P1 of the detecting projection 54c is equal to or more than a gap dimension L1 between the outer surface of the locking piece body 54a and the outer side wall 36 and smaller than a dimension (L1+L2) obtained by adding the thickness L2 of the outer side wall 36 to L1.

In this way, the suitability of the locked state can be easily detected by confirming whether or not the detecting projection 54c projects from the outer surface of the outer side wall 36.

Further, the locking piece 54 includes a rattling preventing projection 54d projecting toward the outer side wall 36 from the locking piece body 54a and pressed against the inner surface of the outer side wall with the locking piece 54 arranged between the outer side wall 36 and the inner side wall 42.

The formation position of the rattling preventing projection 54d is arbitrary, but is preferably a position avoiding the undersides of the locking protrusions 54b. In this embodiment, the rattling preventing projection 54d is formed on a side closer to the base end than the locking protrusions 54b in the locking piece body 54a. Thus, when the locking protrusions 54b ride on the outer surface of the inner side wall 42, the rattling preventing projection 54d can be in a state before contacting the outer side wall 36 and hardly hinders outward deformation of the locking piece body 54a.

Further, since the detecting projection 54c and the rattling preventing projection 54d are preferably located at positions different in a direction intersecting an insertion direction of the detecting projection 54c to hardly hinder a movement of the detecting projection 54c to enter the detection opening 37h1.

In this embodiment, the detecting projection 54c is formed on the upper side edge of the locking piece body 54a, and the rattling preventing projection 54d is formed at a position separated downward from the detecting projection 54c, here, in a vertically intermediate part of the locking piece body 54a.

The rattling preventing projection 54d has a guide surface 54df having a projecting length gradually reduced toward the tip side of the locking piece body 54a. If the locking piece body 54a is inserted to the back between the outer side wall 36 and the inner side wall 42, the guide surface 54df contacts an edge of the outer side wall 36. Thus, the rattling preventing projection 54d can smoothly enter the inside of the outer side wall 36 without being stopped at the edge of the outer side wall 36.

A projecting dimension of the rattling preventing projection 54d may be set to be able to reach the inner surface of the outer side wall 36 with the locking piece body 54a inserted between the outer side wall 36 and the inner side wall 42.

Note that, in this embodiment, locking protrusions 38P are formed on both side parts of the wire pulling-out/accommodating portion 38. Locking pieces 58 each including a locking recess 58a are formed on both side parts of a part of the second housing 50 to be put on the wire pulling-out/accommodating portion 38. The first and second housings 30, 50 are held in the united state also by locking the locking protrusions 38P to the locking recesses 58a of the locking pieces 58 with the first and second housings 30, 50 united. Note that the locking protrusions 38P and the locking pieces 58 may be omitted.

### Concerning Uniting Operation Example and Locked State Suitability Detecting Operation Example

An operation example of detecting the suitability of the locked state during the uniting operation of the first and second housings 30, 50 is described.

The second housing 50 is united with the first housing 30 with the terminal core unit 22 and the wires 16 mounted in the first housing 30.

During the uniting operation, the pair of locking pieces 54 are inserted between the outer side walls 36 and the inner side walls 42. Then, the guide surfaces 54bf of the locking protrusions 54b contact the rear end edges of the inner side walls 42 and the locking piece bodies 54a are resiliently deformed outward. If the pair of locking pieces 54 are further inserted to the back, the locking protrusions 54b move to the back along the outer surfaces of the inner side walls 42. When the locking protrusions 54b reach the locking recesses 43, the locking protrusions 54b enter the locking recesses 43 and the locking piece bodies 54a resiliently return to an original shape.

With the locking protrusions 54b normally locked to the locking recesses 43, the detecting projections 54c are located inside the detection openings 37h1, here at positions where the detecting projections 54c do not project from the outer side walls 36 (see FIGS. 2 and 6). The locked state is detected to be normal by confirming that the detecting projections 54c are located in the detection openings 37h1 and do not project from the outer side walls 36.

In a later stage during the insertion of the locking pieces 54, the guide surfaces 54df of the rattling preventing projections 54d contact the rear end edges of the outer side walls 36 and the rattling preventing projections 54d enter inside the outer side walls 36. In this way, the locking pieces 54 are pressed in directions away from the outer side walls 36 to prevent rattling between the first and second housings 30, 50. Further, since the rattling preventing projections 54d press the locking pieces 54 toward the inner side walls 42, the locked state of the locking protrusions 54b and the locking recesses 43 is easily held.

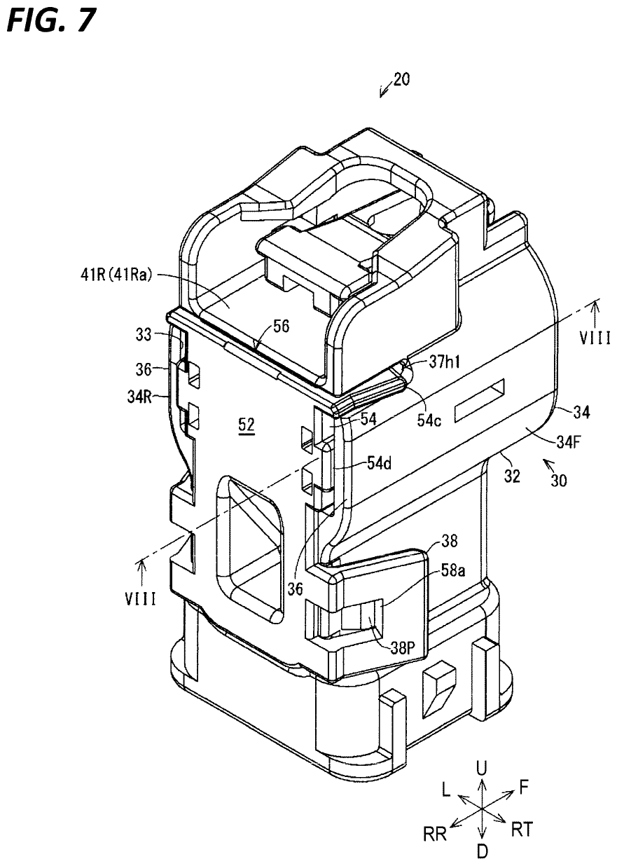

If the locked state of the locking protrusions 54b and the locking recesses 43 are abnormal, it is assumed that the locking protrusions 54b are in contact with the outer surface of the inner side wall 42 around the locking recesses 43. Since the locking piece body 54a is resiliently deformed in the direction away from the inner side wall 42 in this case, the detecting projection 54c is located more outward in the detection opening 37h1 than in the above state. Here, the detecting projection 54c projects further outward than the outer surface of the outer side wall 36 (see FIGS. 7 and 8). Thus, the locked state is detected to be abnormal by confirming from the outside of the connector 20 that the detecting projection 54c is projecting from the outer side wall 36.

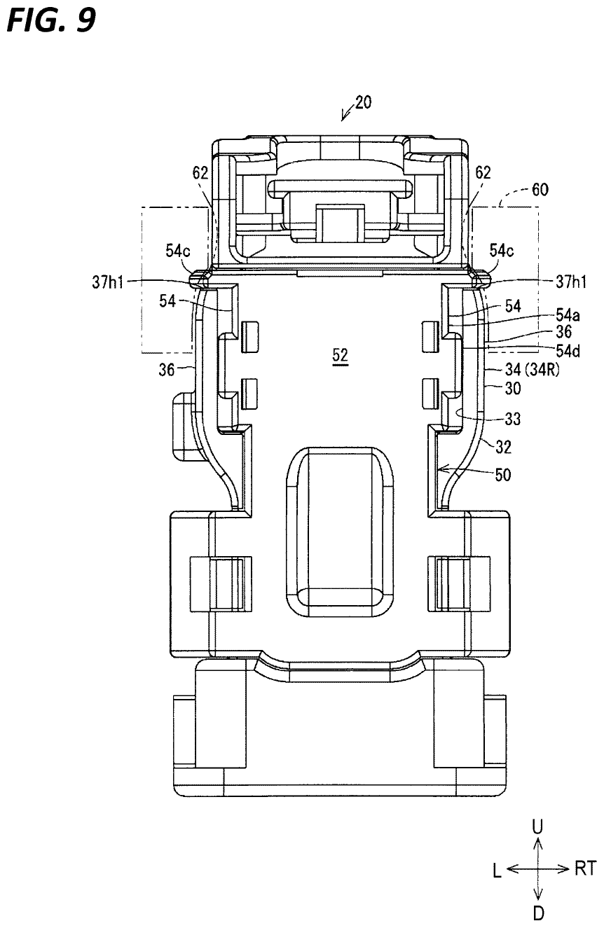

Abnormality detection may be, for example, made using an inspection jig 60 as shown in FIG. 9. The inspection jig 60 has setting surfaces 62 capable of receiving parts around the detecting projections 54c, out of the outer surface of the connector 20. If the locked state is normal, the detecting projections 54c do not project on the outer surface of the connector 20, wherefore the connector 20 can be set on the setting surfaces 62. If the locked state is abnormal, the detecting projections 54c project from the outer surface of the connector 20. Thus, if an attempt is made to set the connector 20 on the setting surfaces 62, the detecting projections 54c interfere with the setting surfaces 62 and the connector 20 cannot be set on the setting surfaces 62. Thus, the suitability of the locked state can be detected based on whether or not the connector 10 can be set on the setting surfaces 62.

A state of the detecting projection 54c may be detected visually, by touch with hand, by an image processing based on an image obtained by imaging the detecting projection 54c, by a sensor for physically detecting the state of the detecting projection 54c or the like.

Even if the locking protrusions 38P are normally locked to the locking pieces 58 in FIG. 7, the locking protrusions 54b may not be possibly normally locked to the locking recesses 43 and, in this embodiment, the abnormally locked state can be easily detected.

### Effects, Etc.

According to the connector 20 configured as described above, the locking protrusions 54b are formed on the locking piece bodies 54a and the locking recesses 43, to which the locking protrusions 54b are locked, are formed in the inner side walls 42. Further, the outer side walls 36 are formed with the detection openings 37h1, in which the detecting projections 54c are arranged. Thus, if the locking protrusions 54b cannot be normally locked to the locking recesses 43, the locking piece body 54a is resiliently deformed toward the outer side wall 36 and the detecting projection 54c is located more outward than in the normally locked state. The suitability of the locked state is easily detected according to the position of the detecting projection 54c in the detection opening 37h1.

Further, if the projecting length of the detecting projection 54c is so set that the detecting projection 54c projects outward from the outer side wall 36 when the locked state is abnormal, the suitability of the locked state is easily detected by confirming the projecting length of the detecting projection 54c from the outer side wall 36.

Further, if the projecting length of the detecting projection 54c is so set that the detecting projection 54c is located more inward than the outer surface of the outer side wall 36 when the locked state is normal, the suitability of the locked state is easily detected based on whether or not the detecting projection projects from the outer wall.

Further, if the first housing 30 is a housing including the terminal accommodating portion 32 and the second housing 50 is a cover for closing the setting opening 33 of the first housing 30, whether or not the setting opening 33 is suitably closed by the mounted cover is easily confirmed by a normal detecting state.

Further, the locking piece 54 includes the rattling preventing projection 54d and the rattling preventing projection 54d is pressed against the inner surface of the outer side wall 36 in the locked state. Thus, the rattling between the first and second housings 30, 50 is suppressed. Further, the rattling preventing projection 54d presses the locking piece 54 toward the inner side wall 42 and, hence, also contributes to maintaining the locked state of the locking protrusions 54b and the locking recesses 43.

Further, since the rattling preventing projection 54d is formed on a side closer to a base end than the locking protrusions 54b in the locking piece body 54a, the rattling preventing projection 54d can be pressed against the outer side wall 36 after the locking protrusions 54b are locked to the locking recesses 43. In this way, the rattling preventing projection 54d can prevent the rattling without hindering workability for locking the locking protrusions 54b to the locking recesses 43.

Further, since the detecting projection 54c and the rattling preventing projection 54d are located at the positions different in the direction intersecting the insertion direction of the detecting projection 54c, the suitability of the locked state is easily detected utilizing the detecting projection 54c while the rattling is suppressed by the rattling preventing projection.

Further, the detection opening 37h1 is formed at the position facing the coupling wall portion 41Ra, out of the outer side wall 36, and the detecting projection 54c is arranged in the detection opening 37h1 outside the coupling wall portion 41Ra. Thus, even if a force is applied around the detection opening 37h1 and to the detecting projection 54c when the connector 20 is inserted or withdrawn, the first and second housings 30, 50 are hardly deformed and the united state is hardly released.

Further, since the detecting projection 54c is formed into the protrusion shape elongated along the projecting direction of the locking piece body 54a, the detecting projection 54c can be thinned, whereby the opening width of the detection opening 37h1 can be reduced. In this way, the strength of the outer side wall 36 is easily ensured. Further, by elongating the detecting projection 54c, the strength of the detecting projection 54c is also easily ensured.

Further, since the detecting projection 54c projects toward the outer side wall 36 at least on the tip of the locking piece body 54a, the detecting projection 54c can be largely displaced outward if the locked state is abnormal. In this way, the abnormality of the locked state is easily detected.

### Modifications

In this embodiment, the united structure of the first housing 30 including the terminal accommodating portion and the second housing 50, which is a cover, is described. The engaging structure described in this embodiment is not limited to that of the above embodiment and is applicable to various connectors having a united structure of a plurality of housings. For example, the above engaging structure is applicable to a united structure of a housing body including cavities for accommodating terminals and a retainer or a cover to be united with the housing body if the united structure includes an inner wall and an outer wall.

Note that the first housing 30 may include only one outer wall. Further, the first housing 30 may include only one inner wall. The first housing 30 may include another wall inside the inner wall or outside the outer wall.

In this embodiment, the locking piece bodies 54a are formed with the locking protrusions 54b and the inner side walls 42 are formed with the locking recesses 43. However, inner side walls may be formed with locking protrusions projecting outward, and locking piece bodies may be formed with locking recesses, to which the locking protrusions are lockable.

Note that the respective configurations described in the above embodiment and each modification can be appropriately combined without contradicting each other.

### LIST OF REFERENCE NUMERALS

12 terminal
16 wire
20 connector
22 terminal core unit
24 terminal holder
30 first housing (housing)
31 partition wall
32 terminal accommodating portion
33 setting opening
34 outer tube portion
34F connector connecting outer end portion
34Fa lock piece
34R Outer accommodating end portion
36 outer side wall (outer wall)
37h1 detection opening
38 wire pulling-out/accommodating portion
38P locking protrusion
39 pull-out end portion
40 inner tube portion
41F connector connecting inner end portion
41R inner accommodating end portion
41Ra coupling wall portion
42 inner side wall (inner wall)
43 locking recess
50 second housing (housing)
52 cover body
54 locking piece
54a locking piece body
54b locking protrusion
54bf guide surface
54c detecting projection
54d rattling preventing projection
54df guide surface
58 locking piece
58a locking recess
60 inspection jig
62 setting surface

1. A connector having a united structure of housings, comprising:
a first housing including an outer wall and an inner wall located inside the outer wall; and
a second housing to be united with the first housing,
the second housing including a locking piece having a locking piece body to be arranged between the outer wall and the inner wall and a detecting projection projecting toward the outer wall from the locking piece body,
one of the locking piece body and the inner wall being formed with a locking protrusion and the other being formed with a locking recess to be locked to the locking protrusion, and
the outer wall being formed with a detection opening, the detecting projection being arranged in the detection opening.

2. The connector of claim 1, wherein a projecting length of the detecting projection is so set that the detecting projection projects outward from the outer wall when a locked state of the locking protrusion to the locking recess is abnormal.

3. The connector of claim 2, wherein the projecting length of the detecting projection is so set that the detecting projection is located more inward than an outer surface of the outer wall when the locked state of the locking protrusion to the locking recess is normal.

4. The connector of claim 1, wherein:
the first housing includes a terminal accommodating portion for accommodating a terminal including a wire connecting portion and a connecting portion to a mating terminal, and the terminal accommodating portion is open on the wire connecting portion side, and
the second housing is a cover for closing an opening of the first housing.

5. The connector of claim 1, wherein the locking piece further includes a rattling preventing projection projecting toward the outer wall from the locking piece body and pressed against an inner surface of the outer wall with the locking piece body arranged between the outer wall and the inner wall.

6. The connector of claim 5, wherein the rattling preventing projection is formed on a side closer to a base end than the locking protrusion or the locking recess in the locking piece body.

7. The connector of claim 5, wherein the detecting projection and the rattling preventing projection are located at positions different in a direction intersecting an insertion direction of the detecting projection.

8. The connector of claim 1, wherein:
the outer wall includes a pair of outer side walls,
the inner wall includes a pair of inner side walls located inside the pair of outer side walls and coupled by a coupling wall portion,
the detection opening is formed at a position facing the coupling wall portion, out of the outer side wall, and
the detecting projection is arranged in the detection opening outside the coupling wall portion.

9. The connector of claim 1, wherein the detecting projection is formed into a protrusion shape elongated along a projecting direction of the locking piece body.

10. The connector of claim 1, wherein the detecting projection projects toward the outer wall at least on a tip of the locking piece body.
